(19) United States
(12) Patent Application Publication
(10) Pub. No.: US 2012/0105428 A1
(43) Pub. Date: May 3, 2012

(54) TRANSPARENT DISPLAY CONFIGURATION MODES

(75) Inventors: Rod G. Fleck, Bellevue, WA (US); Sung Ho Son, Bellevue, WA (US)

(73) Assignee: MICROSOFT CORPORATION, Redmond, WA (US)

(21) Appl. No.: 12/914,761

(22) Filed: Oct. 28, 2010

(51) Int. Cl. G06T 15/00; G09G 5/00

(52) U.S. Cl. 345/419; 345/1.1

(57) ABSTRACT

In embodiments of transparent display configuration modes, a portable device includes a handheld base movably coupled to a display device that is configurable to open and close over the handheld base. The display device displays an image, and the display device includes a first display surface through which the image is viewable and a second display surface through which the image is viewable. The second display surface and the first display surface are viewable from opposite sides of the display device. The display device also includes a display panel controller that controls display modes of the display device for transparent and non-transparent display.

### BACKGROUND

Mobile phones and portable devices that display information when open or closed are typically implemented with two displays. For example, a mobile phone may have a larger, primary display for use when the device is open, and a smaller, secondary display on the back of the device to display the current time or a notification of an incoming call. The current flip, slide, or swivel type of phone devices allow a user to interact with all of the device functions when the primary display is open. However, many of the device functions may be limited or disabled when the primary display is closed over the device and/or when a smaller, secondary display is in use. Additionally, users typically want the smallest possible device to conveniently carry in a pocket or purse, but also want larger user interface surfaces for a primary display, keypad, and potentially a secondary display. Some tablet notebook computers and/or phones that have a single display may be used when in an open or closed position, but need relatively complex rotating hinges and hardware components to position the display screen for use while open or closed.

### SUMMARY

This summary is provided to introduce simplified concepts of transparent display configuration modes that are further described below in the Detailed Description. This summary is not intended to identify essential features of the claimed subject matter, nor is it intended for use in determining the scope of the claimed subject matter.

Transparent display configuration modes are described. In embodiments, a portable device includes a handheld base movably coupled to a display device that is configurable to open and close over the handheld base. The display device displays an image, and the display device includes a first display surface through which the image is viewable and a second display surface through which the image is viewable. The second display surface and the first display surface are viewable from opposite sides of the display device. The display device also includes a display panel controller that controls display modes of the display device for transparent and non-transparent display.

In other embodiments, the display device can be positioned open relative to the handheld base, and the display panel controller can activate the display device to prevent the image from being viewable through the second display surface. Alternatively, the display panel controller can activate the display device for transparency to permit the image being viewable through the second display surface. The display panel controller can also activate the display device for a transparent view of an environment that is viewable through the display device. Alternatively, the display device may be closed over the handheld base, and the display panel controller can activate the display device for transparency to permit the image being viewable through the second display surface. A viewable perspective of the image may also be inverted when the image is viewable through the second display surface.

In other embodiments, an additional display device is integrated into the handheld base and can display an additional image. The display device may be closed over the handheld base, and the display panel controller can activate the display device for transparency so that the image and the additional image are both viewable through the second display surface. A depth-of-field between the image that is viewable through the second display surface over the additional image displayed on the additional display device appears as a pseudo 3-D display.

### BRIEF DESCRIPTION OF THE DRAWINGS

Embodiments of transparent display configuration modes are described with reference to the following drawings. The same numbers are used throughout the drawings to reference like features and components:

FIG. 1 illustrates examples of a portable device and various embodiments of transparent display configuration modes.

FIG. 2 illustrates examples of a portable device and various embodiments of transparent display configuration modes.

FIG. 3 illustrates an example transparent display assembly in accordance with one or more embodiments.

FIG. 4 illustrates example method(s) of transparent display configuration modes in accordance with one or more embodiments.

FIG. 5 illustrates various components of an example device that can implement embodiments of transparent display configuration modes.

### DETAILED DESCRIPTION

Embodiments of transparent display configuration modes are described. A portable device, such as a mobile phone or computer device, includes a display device that can be controlled for transparent and non-transparent display. Optionally, the portable device can also include an additional display device integrated into a handheld base of the portable device. The display device can be movably coupled to the handheld base so that the display device can be positioned to open and close over the handheld base. For example, the display device may open like the display of a notebook computer, slide up like on a slider phone, or flip up like on a flip phone. The display device includes a front display surface and a back display surface, and the front and back display surfaces are viewable from opposite sides of the display device. The display device also includes various display panels and surfaces that are assembled between the front and back display surfaces, and different combinations of the display panels and surfaces may be utilized to implement a transparent display. As described herein, the transparency of a display device may be a percentage of transparency as measured with light detection equipment and/or as visually determined or perceived by a user when viewing through the display device.

In various configuration modes, the display device can be positioned open relative to the handheld base of the portable device, and the display device can be activated to prevent an image from being viewable through the back display surface, while the image is viewable through the front display surface. Alternatively, the display device can be activated for transparency to permit the image being viewable through both the front and back display surfaces. The display device may also be activated for a transparent view of an environment that is viewable through the display device. Alternatively, the display device may be closed over the handheld base, and the display device activated for transparency to permit the image being viewable through the back display surface. Additionally, another image that is displayed on the additional display device, which is integrated into the handheld base of the portable device, may also be viewable through the display device when it is closed over the handheld base and the additional display device.

While features and concepts of the described systems and methods for transparent display configuration modes can be implemented in any number of different environments, systems, devices, and/or various configurations, embodiments of transparent display configuration modes are described in the context of the following example devices, systems, and configurations.

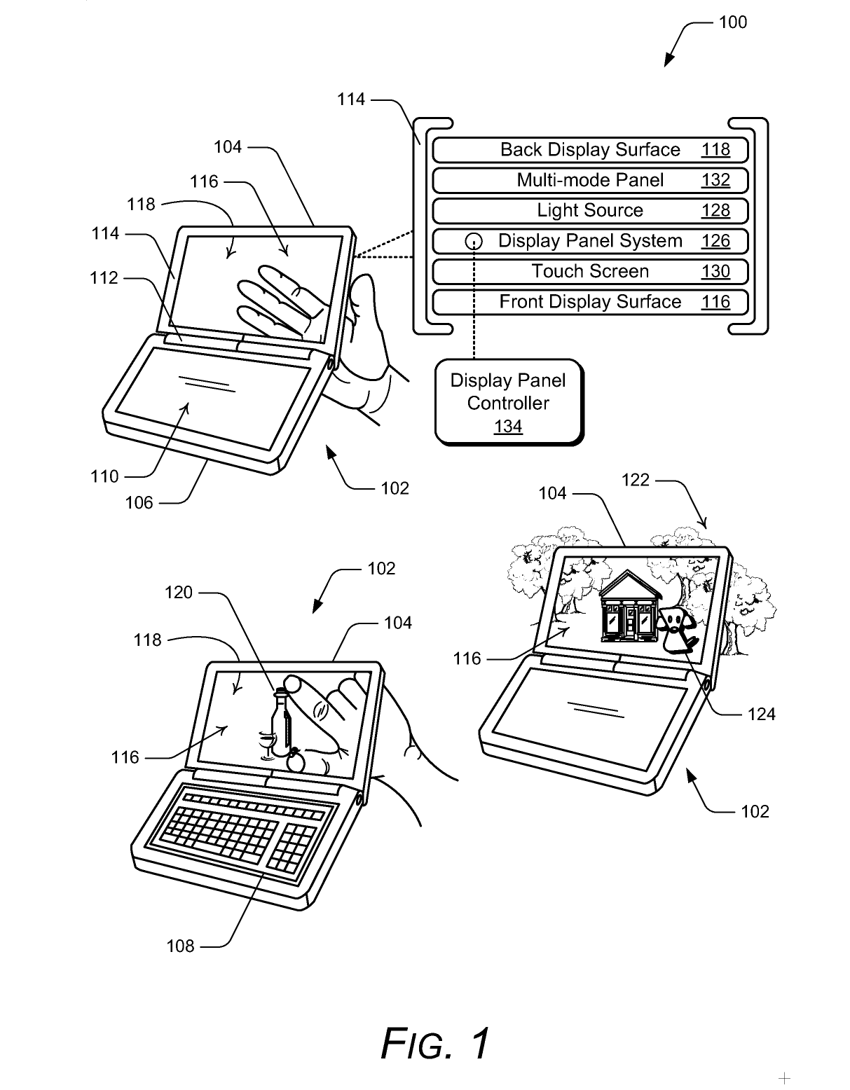

FIG. 1 illustrates examples 100 of a portable device 102 and various embodiments of transparent display assembly. The portable device includes a display device 104 and a handheld base 106 that may include a physical keyboard (shown at 108) or an additional display device 110 as an integrated component of the portable device. The additional display device may be utilized to display text, graphics, images, user interfaces, and/or a virtual keyboard, such as when an implementation of a portable device does not include a physical keyboard. In the examples, the display device 104 is movably coupled at 112 to the handheld base of the portable device, such as with a rotating hinge, slide track, flip mechanism, or other coupling device. The display device can open and close over the handheld base, such as when folded, slid, or flipped closed over the additional display device, folded around to the back of the handheld base, or any position in-between approximately zero degrees (0°) and three-hundred sixty degrees (360°) relative to the handheld base.

The display device 104 includes a display housing 114 that supports various display panels and surfaces that may be utilized to assemble the display device. In this example, the display device includes a front display surface 116 (also referred to as a first display surface), and includes a back display surface 118 (also referred to as a second display surface). The front display surface and the back display surface are viewable from opposite sides of the display device.

A displayed image 120 may be viewable through the front and back display surfaces, and as illustrated, the display device 104 is transparent. As described herein, the transparency of a display device may be a percentage of transparency as measured with light detection equipment and/or as visually determined or perceived by a user when viewing an environment as seen through the various display panels and surfaces of the display device.

In the illustrated examples, a hand may be viewable through the front and back display surfaces of the display device, such as when viewed through the front of the display device. An environment 122 behind the display device can also be viewable through the front and back display surfaces of the display device, and a displayed image may appear projected into the environment for an augmented view of reality. For example, a displayed image 124 of the dog may appear projected into the environment 122 that includes trees and a building behind the display device and viewable through the front and back display surfaces of the display device.

In addition to the front display surface 116 and the back display surface 118, the display device 104 includes a display panel system 126 that is located between the front and back display surfaces. The display panel system is implemented to display images that are then viewable through the front and/or back display surfaces of the display device. The display device may include a light source 128 that illuminates the display panel system for image display. The display device may also include a touch screen 130 that is located between the front and back display surfaces to sense a touch input to either of the front display surface or the back display surface. Alternatively, the display device may include a first touch screen located proximate the front display surface and a second touch screen located proximate the back display surface, and the touch screens sense touch inputs to the respective front and back display surfaces.

The display device 104 also includes a multi-mode panel 132 located between the front display surface 116 and the back display surface 118. In embodiments, the multi-mode panel is operable to switch on and off, such as to prevent an image from being viewable through the front display surface or the back display surface, or for transparency to permit the image being viewable through the front and back display surfaces. The multi-mode panel may be implemented to switch on and/or off the entire panel, sections of the panel, and/or individual pixels of the panel.

In these examples, the display device 104 includes a display panel controller 134 that is implemented to control display modes of the display device for transparent and non-transparent display. The display panel controller can be implemented as computer-executable instructions, such as a software component, and executed by one or more processors to implement various embodiments for a transparent display. In practice, the portable device 102 is implemented with a processor (e.g., a CPU), a graphics processor (e.g., a GPU), and an internal display controller to drive display content to the display device. In the display device 104, the display panel system 126 may include the display panel controller 134 that drives each pixel according to the type of display at various voltages.

In an embodiment, the display panel controller 134 is implemented to invert a viewable perspective of a displayed image when the image is viewable through the back display surface 118. For example, the displayed image 120 that is viewable through the front display surface 116 would appear as a mirror image when viewed through the back display surface if not inverted, or flipped, by the display panel controller so that the displayed image appears in the same perspective when viewed through either of the front or back display surfaces. The display panel controller can be implemented to invert the pixels in each row of a display to reverse an image.

In various configurations, such as when the display device 104 is positioned open relative to the handheld base 106 of the portable device (e.g., as illustrated in the examples), the display panel controller 134 can activate the display device to prevent a displayed image from being viewable through the front display surface 116 or the back display surface 118. Alternatively, the display panel controller can activate the display device for transparency to permit the displayed image being viewable through the front and back display surfaces. Similarly, the display panel controller can activate the display device for a transparent view of the environment 122, which is viewable through the display device. For example, the display panel controller can control and switch on the multi-mode panel 132 of the display device to prevent a displayed image from being viewable through the back display surface, or switch off the multi-mode panel for transparency to permit the displayed image being viewable through the back display surface.

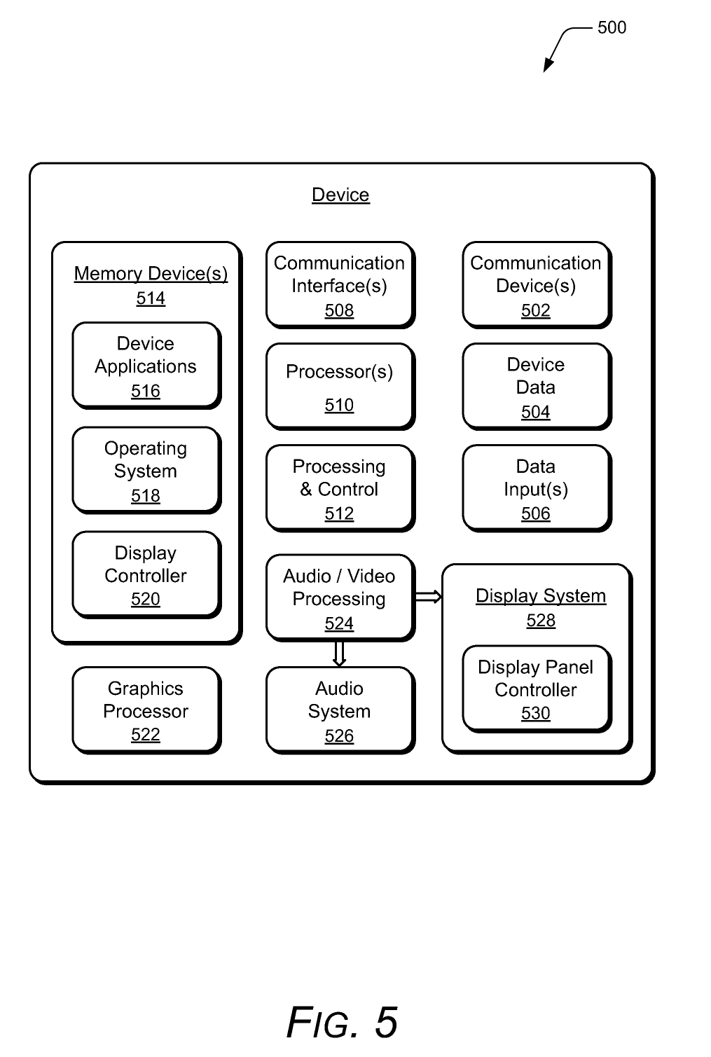

The portable device 102 may be configured as any type of client or user device that includes wired and/or wireless devices, and may be implemented as a consumer, computer (e.g., a laptop or tablet device), portable, communication, phone (e.g., a dual-display phone), appliance, gaming, media playback, and/or electronic device. The portable device can be implemented with one or more processors, data communication components, memory components, navigation components, data processing and control circuits, and a display system. Further, any of the portable devices described herein can be implemented with any number and combination of differing components as further described with reference to the example device shown in FIG. 5.

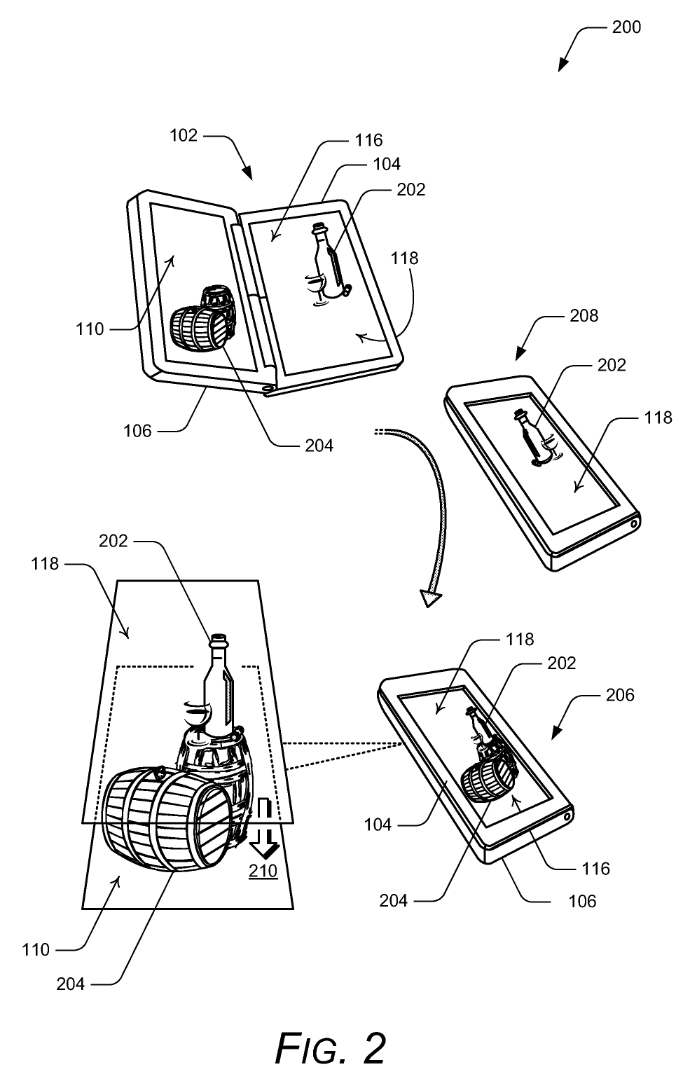

FIG. 2 illustrates examples 200 of the portable device 102 described above with reference to FIG. 1, and various embodiments of transparent display configuration modes. In the examples 200, an image 202 of a wine bottle and glass are displayed on the display device 104, and an image 204 of wine barrels are displayed on the additional display device 110 that is integrated into the handheld base 106 of the portable device 102. The display device 104 may then be positioned closed over the handheld base 106 and both the image of the wine bottle and glass, and the image of the wine barrels, are viewable through the back display surface 118 of the display device. In the illustrated example at 206, the wine bottle and glass appear to be located on one of the wine barrels when viewed through the display surfaces of the display device.

The display panel controller 134, as described with reference to FIG. 1, can be implemented to activate the display device 104 for transparency when the display device is positioned closed over the handheld base 106 to permit the images being viewable through the display device. The display panel controller may also be implemented to invert and/or rotate the displayed images as the orientation and/or configuration of the portable device changes, such as from portrait to landscape mode and vice-versa. The display panel controller can invert and/or rotate a displayed image before, during, and/or after the display device is positioned closed over the handheld base. For example, when the display device is positioned closed over the handheld base at 208, and before the image 202 of the wine bottle and glass is inverted, the reverse of the image is viewable through the back display surface 118 (note that the image 204 of the wine barrels would also be viewable at 208, but are omitted simply for discussion of the inverted image 202). When the image of the wine bottle and glass is then inverted at 206, the image is viewable in the same perspective (e.g., the wine glass is to the left of the wine bottle) as when viewed through the front display surface 116 when the display device is positioned open relative to the handheld base of the portable device.

In embodiments, a depth-of-field indicated at 210 between the image 202 that is viewable through the back display surface 118 over the additional image 204 displayed on the additional display device 110 appears as a pseudo 3-D display. The depth-of-field creates a visual 3-D effect that can be utilized to enhance a user experience for photos, images, graphics, motion video, and/or user interfaces, such as for multi-tasking and application management. This display configuration provides a wide viewing angle and, as an added benefit, a pseudo 3-D display of images does not involve special 3-D glasses for viewing, which limits viewer eyestrain because a viewer is looking at two separate displays, rather than one display with two separate images displayed on the one display.

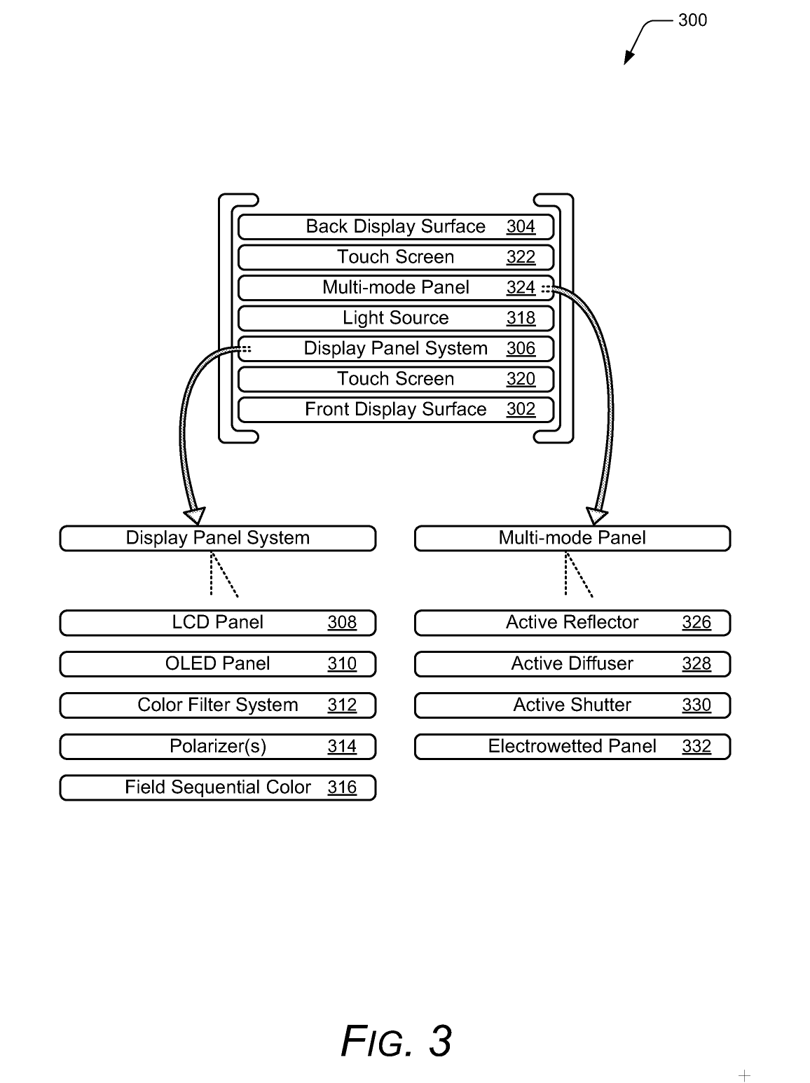

FIG. 3 illustrates an example transparent display assembly 300 that includes various display panels and surfaces as described above with reference to FIG. 1. Embodiments of a transparent display assembly are implemented to maximize light efficiency and transparency. The transparency of a display device may be diminished, primarily due to polarizers (e.g., in an LCD implementation), color filters, and the light efficiency of a light source used to illuminate a display panel. As described above, the transparency of a transparent display may be a percentage of transparency as measured and/or as visually determined or perceived by a user when viewing through the transparent display assembly.

The transparent display assembly 300 includes a front display surface 302 and a back display surface 304. The front, or first, display surface and the back, or second, display surface are viewable from opposite sides of the transparent display assembly. In addition to the front and back display surfaces, the transparent display assembly includes a display panel system 306 that is located between the front and back display surfaces. The display panel system displays images that are viewable through the front and/or back display surfaces of the transparent display assembly.

In various embodiments, the display panel system 306 may include any one or combination of an LCD panel 308, and OLED panel 310, a color filter system 312 that may be implemented as a passive or active system, one or more polarizers 314 that may be implemented as passive or active, and/or an implementation of field sequential color 316. The transparent display assembly 300 may also include a light source 318 that illuminates the display panel system for image display. In this example, the light source is located or positioned between the display panel system 306 and the multi-mode panel 324. Alternatively, the light source can be implemented as a front-light that is located or positioned between the display panel system and a touch screen 320. The transparent display assembly includes the first touch screen 320 located proximate the front display surface 302 and a second touch screen 322 located proximate the back display surface 304. The touch screens are implemented to sense touch inputs to the respective front and back display surfaces.

The LCD panel 308 can be implemented as a transparent LCD panel. An LCD implementation includes polarizers, and may include an implementation of field sequential color rather than using color filters. The OLED panel 310 can be implemented with transparent panel material for a transparent OLED panel implementation. Alternatively, the OLED panel may include a two-sided direct emitter for a dual-sided display. An active reflector may then be implemented to permit or prevent one side of a display from being viewable. The color filter system 312 can be implemented for a percentage of transparency that permits an image being viewable through the display device. Similarly, the polarizers 314 can be implemented for a percentage of transparency that permits the image being viewable through the display device. In embodiments, an implementation of field sequential color 316 may be utilized in place of the color filters.

The transparent display assembly 300 also includes a multi-mode panel 324 located between the front display surface 302 and the back display surface 304. In embodiments, the multi-mode panel is implemented to switch on and off, such as to prevent an image from being viewable through the front display surface 302 or the back display surface 304, or for transparency to permit the image being viewable through the front and back display surfaces. The multi-mode panel may be implemented to switch on and/or off the entire panel, sections of the panel, and/or individual pixels of the panel. In various embodiments, the multi-mode panel may include any one or combination of an active reflector 326, an active diffuser 328, an active shutter 330, and/or an electrowetted panel 332 implementation.

The active reflector 326 and the active diffuser 328 are implemented to switch on to prevent an image from being viewable through the front display surface 302 or the back display surface 304, and implemented to switch off for transparency to permit the image being viewable through the front and back display surfaces. Similarly, the active shutter 330 is implemented to close to prevent the image from being viewable through the front display surface or the back display surface, and is implemented to open for transparency to permit the image being viewable through the front and back display surfaces. The active reflector 326 can be implemented as a dual-state mirror having a transparent state for transparency, and a reflective state to reflect and recycle light that is lost, such as from an illuminated light guide to illuminate the display. The active shutter 330 can be implemented as an LCD shutter that provides for variable light transmissivity based on an applied voltage. In embodiments, an electrowetting implementation of the electrowetted panel 332 does not include polarizers, and may or may not include color filters. Any of the described multi-mode panel solutions, such as a reflector, diffuser, shutter, or electrowetted panel, can be implemented to operate on the whole panel, sections of the panel, and/or on a pixel-by-pixel basis.

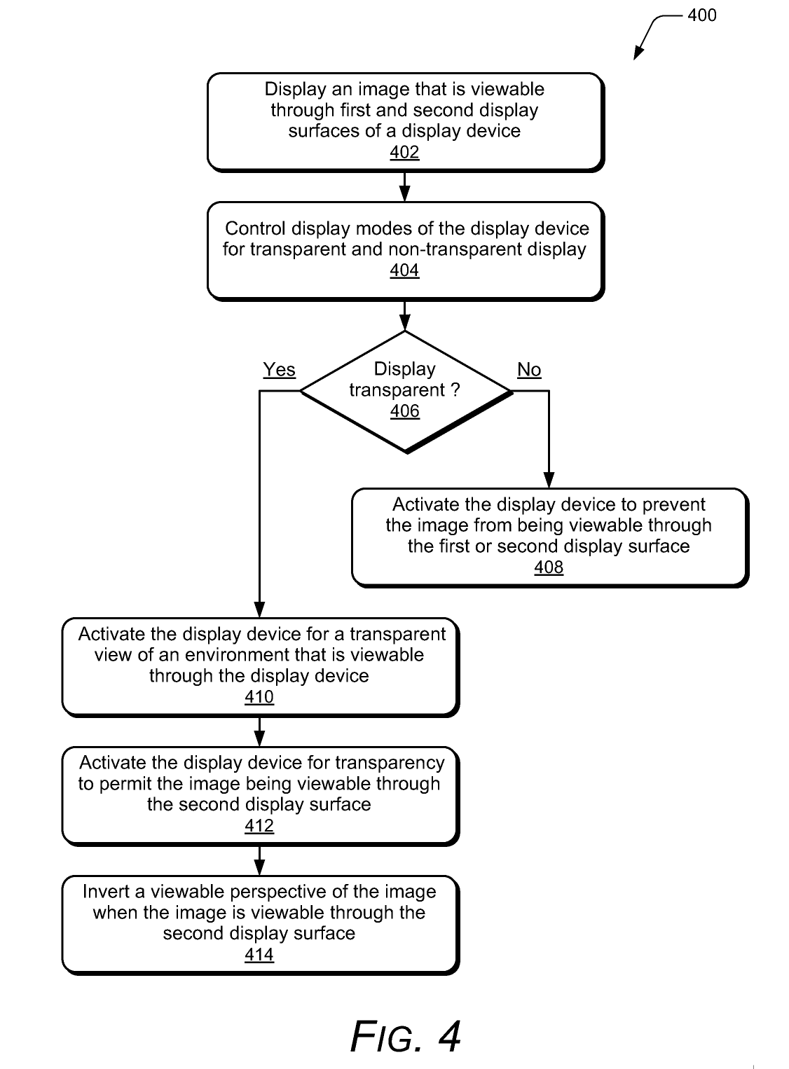

Example method 400 is described with reference to FIG. 4 in accordance with one or more embodiments of transparent display configuration modes. Generally, any of the functions, methods, procedures, components, and modules described herein can be implemented using software, firmware, hardware (e.g., fixed logic circuitry), manual processing, or any combination thereof. A software implementation represents program code that performs specified tasks when executed by a computer processor. The example methods may be described in the general context of computer-executable instructions, which can include software, applications, routines, programs, objects, components, data structures, procedures, modules, functions, and the like. The program code can be stored in one or more computer-readable memory devices, both local and/or remote to a computer processor. The methods may also be practiced in a distributed computing environment by multiple computer devices. Further, the features described herein are platform-independent and can be implemented on a variety of computing platforms having a variety of processors.

FIG. 4 illustrates example method(s) 400 of transparent display configuration modes. The order in which the method blocks are described are not intended to be construed as a limitation, and any number of the described method blocks can be combined in any order to implement a method, or an alternate method.

At block 402, an image is displayed that is viewable through a first display surface of a display device, and viewable through a second display surface of the display device. The first display surface and the second display surface are viewable from opposite sides of the display device. For example, portable device 102 (FIG. 1) includes a display device 104, which has a front display surface 116 (e.g., also referred to as a first display surface), and a back display surface 118 (e.g., also referred to as a second display surface). The first and the second display surfaces are viewable from opposite sides of the display device. The displayed image 120 is viewable through the front and back display surfaces when the display device is operably transparent.

At block 404, display modes of the display device are controlled for transparent and non-transparent display. The display modes are based, at least in part, on a relative position of the display device that is configurable to open and close over the handheld base of the portable device to which the display device is movably coupled. For example, the display panel controller 134 controls display modes of the display device 104 for transparent and non-transparent display. The display device is movably coupled at 112 to the handheld base 106 of the portable device 102, and the display device can open and close over the handheld base.

At block 406, a determination is made as to whether the display is to be initiated for transparent display. If the display device is not initiated for transparent display (i.e., “no” from block 406), then at block 408, the display device is activated to prevent the image from being viewable through the first display surface or the second display surface. For example, the display panel controller 134 activates the display device 104 to prevent the displayed image 120 from being viewable through the back display surface 118, such as when the display device is positioned open relative to the handheld base 106 of the portable device, and the displayed image is viewable through the front display surface 116 of the display device. In an implementation, the display panel controller switches on the multi-mode panel 132 of the display device to prevent the displayed image from being viewable through the back display surface.

If the display device is initiated for transparent display (i.e., “yes” from block 406), then at block 410, the display device is activated for a transparent view of an environment that is viewable through the display device. For example, the display panel controller 134 activates the display device 104 for a transparent view of the environment 122 that is viewable through the display device, such as when the display device is positioned open relative to the handheld base 106 of the portable device. In an implementation, the display panel controller switches off the multi-mode panel 132 of the display device for transparency.

At block 412, the display device is activated for transparency to permit the image being viewable through the second display surface. For example, the display panel controller 134 activates the display device 104 for transparency to permit the displayed image 120 being viewable through the back display surface. The display device may be activated for transparency when the display device is positioned open relative to the handheld base 106 of the portable device, and the displayed image is viewable through the front display surface 116 of the display device. The display device may also be activated for transparency when the display device is positioned closed over the handheld base of the portable device.

At block 414, a viewable perspective of the image is inverted when the image is viewable through the second display surface. For example, the display panel controller 134 inverts a viewable perspective of the displayed image 120 when the image is viewable through the back display surface 118 so that the displayed image appears in the same perspective when viewed through either of the front or back display surfaces of the display device. The display panel controller also inverts and/or rotates displayed images as the orientation and/or configuration of the portable device changes, such as from portrait to landscape mode and vice-versa. For example, an image may be inverted when the display device is positioned closed over the handheld base of the portable device and the image is viewable through the back display surface. An image may also be inverted when the display device is positioned open relative to the handheld base and a first person views the image through the front display surface and a second person views the image, inverted, through the back display surface.

FIG. 5 illustrates various components of an example device 500 that can be implemented as a portable device as described with reference to any of the previous FIGS. 1-4. In embodiments, the device may be implemented as any one or combination of a fixed or mobile device, in any form of a consumer, computer, portable, user, communication, phone, navigation, television, appliance, gaming, media playback, and/or electronic device. The device may also be associated with a user (i.e., a person) and/or an entity that operates the device such that a device describes logical devices that include users, software, firmware, hardware, and/or a combination of devices.

The device 500 includes communication devices 502 that enable wired and/or wireless communication of device data 504, such as received data, data that is being received, data scheduled for transmission, data packets of the data, etc. The device data or other device content can include configuration settings of the device, media content stored on the device, and/or information associated with a user of the device. Media content stored on device can include any type of audio, video, and/or image data. The device includes one or more data inputs 506 via which any type of data, media content, and/or inputs can be received, such as user-selectable inputs, messages, communications, music, television content, recorded video content, and any other type of audio, video, and/or image data received from any content and/or data source.

The device 500 also includes communication interfaces 508, such as any one or more of a serial, parallel, network, or wireless interface. The communication interfaces provide a connection and/or communication links between the device and a communication network by which other electronic, computing, and communication devices communicate data with the device.

The device 500 includes one or more processors 510 (e.g., any of microprocessors, controllers, and the like) which process various computer-executable instructions to control the operation of the device. Alternatively or in addition, the device can be implemented with any one or combination of software, hardware, firmware, or fixed logic circuitry that is implemented in connection with processing and control circuits which are generally identified at 512. Although not shown, the device can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

The device 500 also includes one or more memory devices 514 (e.g., computer-readable storage media) that enable data storage, such as random access memory (RAM), non-volatile memory (e.g., read-only memory (ROM), flash memory, etc.), and a disk storage device. A disk storage device may be implemented as any type of magnetic or optical storage device, such as a hard disk drive, a recordable and/or rewriteable disc, and the like.

Computer readable media can be any available medium or media that is accessed by a computing device. By way of example, and not limitation, computer readable media may comprise storage media and communications media. Storage media include volatile and non-volatile, removable and non-removable media implemented in any method or technology for storage of information, such as computer-readable instructions, data structures, program modules, or other data. Storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by a computer.

Communication media typically embody computer-readable instructions, data structures, program modules, or other data in a modulated data signal, such as carrier wave or other transport mechanism. Communication media also include any information delivery media. The term modulated data signal means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

A memory device 514 provides data storage mechanisms to store the device data 504, other types of information and/or data, and various device applications 516. For example, an operating system 518 and a display controller 520 can be maintained as software applications with a memory device and executed on the processors. The device applications may also include a device manager, such as any form of a control application, software application, signal processing and control module, code that is native to a particular device, a hardware abstraction layer for a particular device, and so on.

The device 500 may also include a graphics processor 522, and includes an audio and/or video processing system 524 that generates audio data for an audio system 526 and/or generates display data for a display system 528. The audio system and/or the display system may include any devices that process, display, and/or otherwise render audio, video, display, and/or image data. For example, the display system includes a display panel controller 530. Display data and audio signals can be communicated to an audio device and/or to a display device via an RF (radio frequency) link, S-video link, composite video link, component video link, DVI (digital video interface), analog audio connection, or other similar communication link. In implementations, the audio system and/or the display system are external components to the device. Alternatively, the audio system and/or the display system are integrated components of the example device.

Although embodiments of transparent display configuration modes have been described in language specific to features and/or methods, the subject of the appended claims is not necessarily limited to the specific features or methods described. Rather, the specific features and methods are disclosed as example implementations of transparent display configuration modes.

1. A portable device, comprising:
a display device configured to display an image, the display device including a first display surface through which the image is viewable and a second display surface through which the image is viewable, the second display surface and the first display surface viewable from opposite sides of the display device;
a handheld base of the portable device movably coupled to the display device that is configurable to open and close over the handheld base; and
a display panel controller configured to control display modes of the display device for transparent and non-transparent display.

2. A portable device as recited in claim 1, wherein the display device is positioned open relative to the handheld base, the image is viewable through the first display surface, and wherein the display panel controller is configured to activate the display device to prevent the image from being viewable through the second display surface.

3. A portable device as recited in claim 1, wherein the display device is positioned open relative to the handheld base, the image is viewable through the first display surface, and wherein the display panel controller is configured to activate the display device for transparency to permit the image being viewable through the second display surface.

4. A portable device as recited in claim 1, wherein the display device is positioned open relative to the handheld base, and wherein the display panel controller is configured to activate the display device for a transparent view of an environment that is viewable through the display device.

5. A portable device as recited in claim 1, wherein the display device is positioned closed over the handheld base, and wherein the display panel controller is configured to activate the display device for transparency to permit the image being viewable through the second display surface.

6. A portable device as recited in claim 1, wherein the display panel controller is further configured to invert a viewable perspective of the image when the image is viewable through the second display surface.

7. A portable device as recited in claim 1, further comprising an additional display device integrated into the handheld base and configured to display an additional image, wherein:
the display device is positioned closed over the handheld base;
the display panel controller is configured to activate the display device for transparency; and wherein
the image and the additional image are both viewable through the second display surface.

8. A portable device as recited in claim 7, wherein a depth-of-field between the image that is viewable through the second display surface over the additional image displayed on the additional display device appears as a pseudo 3-D display.

9. A portable device as recited in claim 7, wherein the image that is displayed by the display device is text that appears displayed over the additional image that is displayed as at least one of a user interface, a digital photo, or additional text on the additional display device.

10. A display system, comprising:
a primary display device that includes a display panel system configured to display an image;
a first display surface of the primary display device through which the image is viewable;
a second display surface of the primary display device through which the image is viewable when the primary display device is configured for transparent display, the second display surface and the first display surface configured on opposite sides of the primary display device;
a display panel controller configured to control display modes of the primary display device for transparent and non-transparent display; and
a secondary display device configured to display an additional image.

11. A display system as recited in claim 10, wherein the image is viewable through the first display surface, and wherein the display panel controller is configured to activate the display panel system for transparency to permit the image being viewable through the second display surface.

12. A display system as recited in claim 10, wherein the image is viewable through the first display surface, and wherein the display panel controller is configured to activate the display panel system for a transparent view of an environment that is viewable through the primary display device.

13. A display system as recited in claim 10, wherein the primary display device is positioned over the secondary display device, and wherein the display panel controller is configured to activate the display panel system for transparency to permit both the image and the additional image being viewable through the second display surface.

14. A display system as recited in claim 13, wherein a depth-of-field between the image that is viewable through the second display surface over the additional image displayed on the secondary display device appears as a pseudo 3-D display.

15. A method, comprising:
displaying an image that is viewable through a first display surface of a display device, and viewable through a second display surface of the display device, the second display surface and the first display surface viewable from opposite sides of the display device; and
controlling display modes of the display device for transparent and non-transparent display, based at least in part on a relative position of the display device that is configurable to open and close over a handheld base of a portable device to which the display device is movably coupled.

16. A method as recited in claim 15, further comprising activating the display device to prevent the image from being viewable through the second display surface when the display device is positioned open relative to the handheld base of the portable device, and the image is viewable through the first display surface of the display device.

17. A method as recited in claim 15, further comprising activating the display device for transparency to permit the image being viewable through the second display surface when the display device is positioned open relative to the handheld base of the portable device, and the image is viewable through the first display surface of the display device.

18. A method as recited in claim 15, further comprising activating the display device for a transparent view of an environment that is viewable through the display device when the display device is positioned open relative to the handheld base of the portable device.

19. A method as recited in claim 15, further comprising activating the display device for transparency to permit the image being viewable through the second display surface when the display device is positioned closed over the handheld base of the portable device.

20. A method as recited in claim 15, further comprising inverting a viewable perspective of the image when the image is viewable through the second display surface.
